(19) United States
(12) Patent Application Publication
(10) Pub. No.: US 2014/0175911 A1
(43) Pub. Date: Jun. 26, 2014

(54) STATOR AND MOTOR HAVING THE SAME

(71) Applicant: SAMSUNG ELECTRO-MECHANICS CO., LTD., Suwon (KR)

(72) Inventors: Sung Tai Jung, Suwon (KR); Sang Ho Seo, Suwon (KR)

(73) Assignee: SAMSUNG ELECTRO-MECHANICS CO., LTD., Suwon (KR)

(21) Appl. No.: 14/100,966

(22) Filed: Dec. 9, 2013

(30) Foreign Application Priority Data
Dec. 20, 2012 (KR) 10-2012-0149699

(51) Int. Cl. H02K 1/18

(52) U.S. Cl. CPC H02K 1/18
USPC 310/43; 310/216.113

(57) ABSTRACT

Disclosed herein is a stator including: a plurality of stator cores; a coil wound around each of the plurality of stator cores; and an injection part injection-molded between the plurality of stator cores.

### CROSS REFERENCE TO RELATED APPLICATION

This application claims the benefit of Korean Patent Application No. 10-2012-0149699, filed on Dec. 20, 2012, entitled “Stator and Motor Having the Same”, which is hereby incorporated by reference in its entirety into this application.

### BACKGROUND OF THE MENTION

1. Technical Field

The present invention relates to a stator and a motor having the same.

2. Description of the Related Art

In an inner rotor type motor according to the prior art, as disclosed in Korean Patent Laid-Open Publication No. 2010-0039163, a rotor rotates by electromagnetic force with a coil wound around a stator and a magnet provided in the rotor.

Generally, as disclosed in Japanese Patent Laid-Open Publication No. 2003-079081, the coil is wound around a core of the stator.

However, since the core of the stator is formed in a circular shape, it may not be easy to wind (roll) the coil around the core and a space factor of the coil may also be decreased, such that performance may be deteriorated.

### PRIOR ART DOCUMENT

### Patent Document

(Patent Document 1) Korean Patent Laid-Open Publication No. 2010-0039163

(Patent Document 2) Japanese Patent Laid-Open Publication No. 2003-079081

### SUMMARY OF THE INVENTION

The present invention has been made in an effort to provide a stator capable of easily winding a coil, and a motor having the same.

In addition, the present invention has been made in an effort to provide a stator capable of integrally forming a stator core by injection molding, and a motor having the same.

According to a preferred embodiment of the present invention, there is provided a stator including: a plurality of stator cores; a coil wound around each of the plurality of stator cores; and an injection part injection-molded between the plurality of stator cores.

The plurality of stator cores may include: a plurality of support parts; and a plurality of teeth parts extended from the plurality of support parts, respectively, and having the coil wound therearound.

The injection part may be integrally formed on outer surfaces of end portions of the plurality of teeth parts by insert injection molding.

The teeth part may include: a winding part extended from the support part and having the coil wound therearound; and an extension part formed at an end portion of the winding part to prevent separation of the coil, and the injection part may be formed along an outer surface of the extension part.

The extension part may be extended from the end portion of the winding part to both sides in a circumferential direction.

The stator may further include a plurality of stator blocks coupled between the plurality of stator cores.

The stator may further include a plurality of stator blocks coupled between the support parts of the plurality of stator cores and extended from the support parts in a circumferential direction.

According to another preferred embodiment of the present invention, there is provided a stator including: a plurality of stator cores; a coil wound around each of the plurality of stator cores; and a plurality of stator blocks coupled between the plurality of stator cores.

The plurality of stator cores may include: a plurality of support parts; and a plurality of teeth parts extended from the plurality of support parts, respectively, and having the coil wound therearound.

The plurality of stator blocks may be coupled between the support parts of the stator core and extended from the support parts in a circumferential direction.

The stator may further include an injection part integrally formed on outer surfaces of the plurality of teeth parts by insert injection molding.

The teeth part may include: a winding part extended from the support part and having the coil wound therearound; and an extension part formed at an end portion of the winding part to prevent separation of the coil, and the injection part may be formed along an outer surface of the extension part.

The extension part may be extended from the end portion of the winding part to both sides in a circumferential direction.

According to another preferred embodiment of the present invention, there is a motor including: a rotor including a shaft, a rotor core coupled to the shaft, and a magnet mounted in the rotor core; and a stator including a plurality of stator cores positioned so as to face the magnet, a coil wound around each of the plurality of stator cores, and an injection part injection molded between the plurality of stator cores.

The plurality of cores may include: a plurality of support parts; and a plurality of teeth parts extended from the plurality of support parts, respectively, and having the coil wound therearound.

The injection part may be integrally formed on outer surfaces of end portions of the plurality of teeth parts by insert injection molding.

The teeth part may include: a winding part extended from the support part and having the coil wound therearound; and an extension part formed at an end portion of the winding part to prevent separation of the coil, and the injection part may be formed along an outer surface of the extension part.

The extension part may be extended from the end portion of the winding part to both sides in a circumferential direction.

The stator may further include a plurality of stator blocks coupled between the plurality of stator cores.

The stator may further include a plurality of stator blocks coupled between the support parts of the plurality of stator cores and extended from the support parts in a circumferential direction.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view showing a stator according to a preferred embodiment of the present invention;

FIG. 2 is a plan view showing a state in which a stator block is not coupled in the stator according to the preferred embodiment of the present invention; and

FIG. 3 is a plan view showing a motor having a stator according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

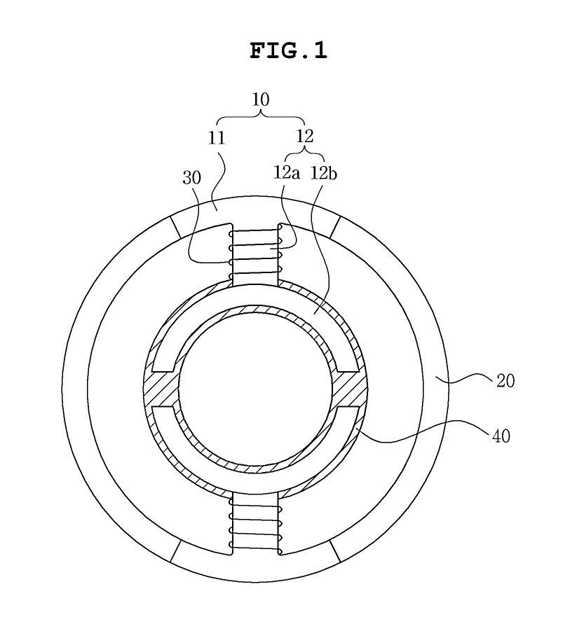

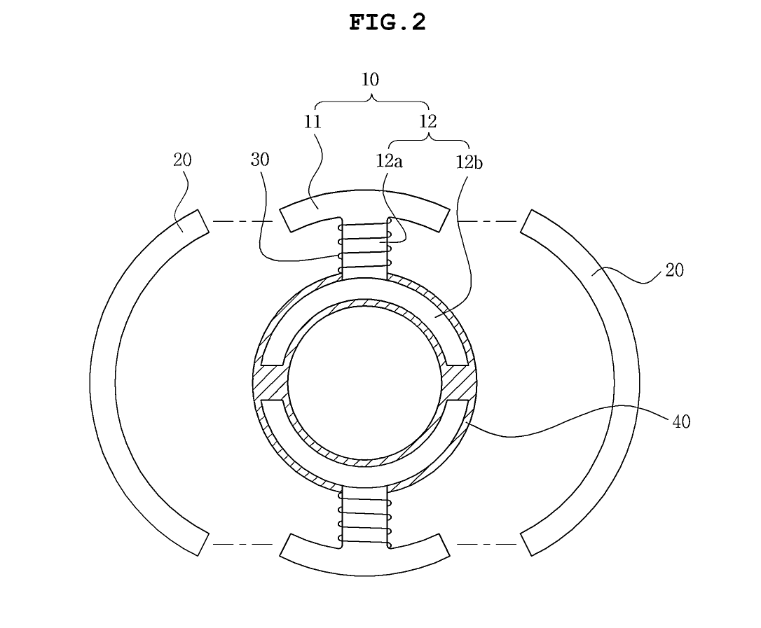

FIG. 1 is a plan view showing a stator according to a preferred embodiment of the present invention, and FIG. 2 is a plan view showing a state in which a stator block 20 is not coupled in the stator according to the preferred embodiment of the present invention.

Referring to FIGS. 1 and 2, the stator according to the preferred embodiment of the present invention may include a plurality of stator cores 10, a coil 30 wound (rolled) around each of the plurality of stator cores 10, an injection part 40 injection-molded between the plurality of stator cores 10, and a plurality of stator blocks 20 coupled between the plurality of stator cores 10.

In more detail, the stator cores 10 are formed in plural to provide supporters having the coil 30 wound therearound.

In addition, the plurality of stator cores 10 include a plurality of support parts 11 and a teeth part 12 extended from each of the plurality of support parts 11 and having the coil 30 wound therearound.

Here, the teeth part 12 includes a winding part 12a extended from the support part 11 and having the coil 30 wound therearound and an extension part 12b formed at an end portion of the winding part 12a to prevent separation of the coil 30. In this case, the extension part 12b may be extended from the end portion of the winding part 12a to both sides in a circumferential direction.

Meanwhile, for example, the support part 11 and the extension part 12b of the stator core 10 may be formed to have shapes corresponding to each other and extended in the circumferential direction. In this case, the winding part 12a may be formed so as to be connected to the support part 11 and the extension part 12b in a direction perpendicular to the support part 11 and the extension part 12b.

Meanwhile, the stator according to the preferred embodiment of the present invention may further include the injection part 40 integrally formed on an outer surface of an end portion of the teeth part 12 by injection-molding. In this case, the injection part 40 may be formed along an outer surface of the extension part 12b.

Here, the inject part 40 is extended in the circumferential direction and integrally formed while connecting the plurality of extension parts 12b to each other. Therefore, the stator core 10 may be integrally formed through the injection part 40, such that the stator core may be easily manufactured and handled, thereby making it possible increase mass-productivity.

In addition, a central portion of the injection part 40 may be formed with a through hole (not shown) so that a rotor may be disposed therein.

The stator blocks 20 are formed in plural and coupled between the plurality of stator cores 10 to support the plurality of stator cores 10, respectively. In this case, the stator block 20 may be fixed to the stator cores by welding or adhesion.

In addition, the stator block 20 may be formed to be extended from the stator core 10 in the circumferential direction, but the present invention is not limited thereto. In this case, the stator block 20 may be extended, for example, from the support part 11 of the stator core 10 in the circumferential direction.

The stator according to the preferred embodiment of the present invention configured as described above has a structure in which the stator block 20 is coupled to the stator core 10, such that it may be easy to wind the coil 30 around the stator core 10.

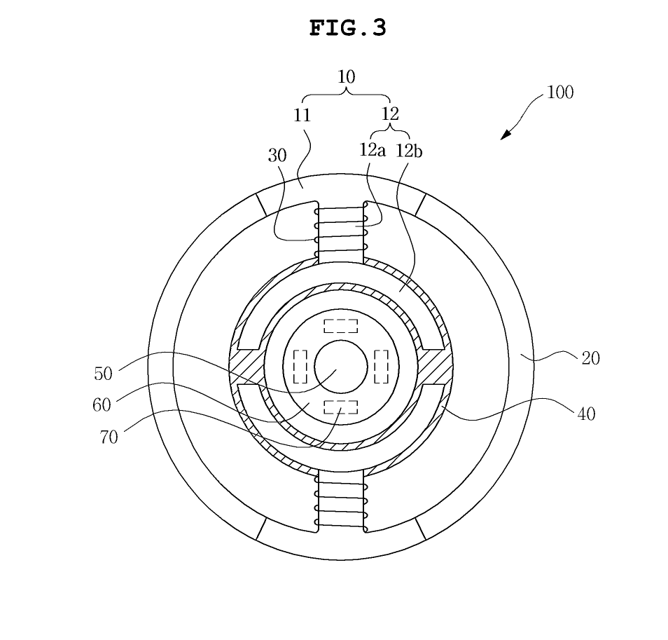

FIG. 3 is a plan view showing a motor having a stator according to the preferred embodiment of the present invention.

Referring to FIG. 3, the motor 100 according to the preferred embodiment of the present invention may be configured to include a rotor including a shaft 50, a rotor core 60, and a magnet 70 and a stator including a stator core 10, a coil 30, an injection part 40, and a stator block 20.

The rotor core 60 is coupled to an outer peripheral surface of the shaft 50 In addition, an inner portion of the rotor core 60 may be provided with a reception part (not shown) for receiving the magnet 70.

The magnet 70 may be received in the reception part of the rotor core 60 and provided at a position at which the magnet faces the coil 30 wound around the stator core 10. Here, the magnet 70 and the coil 30 may be spaced apart from each other by a predetermined distance so as to face each other. In this case, the magnet 70 and the coil 30 may be installed at the same height as each other.

Meanwhile, the motor 100 according to the preferred embodiment of the present invention may further include a housing in which the rotor and the stator are mounted. In this case, the shaft 50 of the rotor may be coupled to upper and lower ends of the housing by the bearings.

The stator cores 10 are formed in plural to provide supporters having the coil 30 wound therearound.

In addition, the plurality of stator cores 10 include a plurality of support parts 11 and a teeth part 12 extended each of the plurality of support parts 11 and having the coil 30 wound therearound.

Here, the teeth part 12 includes a winding part 12a extended from the support part 11 and having the coil 30 wound therearound and an extension part 12b formed at an end portion of the winding part 12a to prevent separation of the coil 30. In this case, the extension part 12b may be extended from the end portion of the winding part 12a to both sides in a circumferential direction.

Meanwhile, for example, the support part 11 and the extension part 12b of the stator core 10 may be formed to have shapes corresponding to each other and extended in the circumferential direction. In this case, the winding part 12a may be formed so as to be connected to the support part 11 and the extension part 12b in a direction perpendicular to the support part 11 and the extension part 12b.

Meanwhile, the stator according to the preferred embodiment of the present invention may further include the injection part 40 integrally formed on an outer surface of an end portion of the teeth part 12 by insert injection-molding. In this case, the injection part 40 may be formed along an outer surface of the extension part 12b.

Here, the inject part 40 is extended in the circumferential direction and integrally formed while connecting the plurality of extension parts 12b to each other. Therefore, the stator core 10 may be integrally formed through the injection part 40, such that the stator core may be easily manufactured and handled, thereby making it possible to increase manufacturability.

In addition, a central portion of the injection part 40 may be formed with a through hole (not shown) so that the rotor core 60 may be disposed therein. In addition, an inner peripheral surface of the injection part 40 and an outer peripheral surface of the rotor core may have shapes corresponding to each other.

The stator blocks 20 are formed in plural and coupled between the plurality of stator cores 10 to support the plurality of stator cores 10, respectively. In this case, the stator block 20 may be fixed to the stator cores by welding or adhesion.

In addition, the stator block 20 may be formed to be extended from the stator core 10 in the circumferential direction, but the present invention is not limited thereto. In this case, the stator block 20 may be extended, for example, from the support part 11 of the stator core 10 in the circumferential direction.

The motor 100 having the stator according to the preferred embodiment of the present invention configured as described above has a structure in which the stator block 20 is coupled to the stator core 10, such that it may be easy to wind the coil 30 around the stator core 10.

According to the present invention, the stator is configured of the stator cores and the stator block, such that it may be easy to wind the coil around the stator core and to assemble the stator. In addition, it is easy to perform an intermediate test, such that defects may be decreased.

Further, according to the present invention, the stator core may be integrally formed by injection molding, such that the stator core may be easily manufactured and handled, thereby making it possible to increase mass-productivity.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A stator comprising:
a plurality of stator cores;
a coil wound around each of the plurality of stator cores; and
an injection part injection-molded between the plurality of stator cores.

2. The stator as set forth in claim 1, wherein the plurality of stator cores include:
a plurality of support parts; and
a plurality of teeth parts extended from the plurality of support parts, respectively, and having the coil wound therearound.

3. The stator as set forth in claim 2, wherein the injection part is integrally formed on outer surfaces of end portions of the plurality of teeth parts by insert injection molding.

4. The stator as set forth in claim 3, wherein the teeth part includes:
a winding part extended from the support part and having the coil wound therearound; and
an extension part formed at an end portion of the winding part to prevent separation of the coil, and
the injection part is formed along an outer surface of the extension part.

5. The stator as set forth in claim 4 wherein the extension part is extended from the end portion of the winding part to both sides in a circumferential direction.

6. The stator as set forth in claim 1, further comprising a plurality of stator blocks coupled between the plurality of stator cores.

7. The stator as set forth in claim 2, further comprising a plurality of stator blocks coupled between the support parts of the plurality of stator cores and extended from the support parts in a circumferential direction.

8. A stator comprising:
a plurality of stator cores;
a coil wound around each of the plurality of stator cores; and
a plurality of stator blocks coupled between the plurality of stator cores.

9. The stator as set forth in claim 8, wherein the plurality of stator cores include:
a plurality of support parts; and
a plurality of teeth parts extended from the plurality of support parts, respectively, and having the coil wound therearound.

10. The stator as set forth in claim 9, wherein the plurality of stator blocks are coupled between the support parts of the stator core and extended from the support parts in a circumferential direction.

11. The stator as set forth in claim 9, further comprising an injection part integrally formed on outer surfaces of the plurality of teeth parts by insert injection molding.

12. The stator as set forth in claim 9, wherein the teeth part includes:
a winding part extended from the support part and having the coil wound therearound; and
an extension part formed at an end portion of the winding part to prevent separation of the coil, and
the injection part is formed along an outer surface of the extension part.

13. The stator as set forth in claim 12, wherein the extension part is extended from the end portion of the winding part to both sides in a circumferential direction.

14. A motor comprising:
a rotor including a shaft, a rotor core coupled to the shaft, and a magnet mounted in the rotor core; and
a stator including a plurality of stator cores positioned so as to face the magnet, a coil wound around each of the plurality of stator cores, and an injection part injection molded between the plurality of stator cores.

15. The motor as set forth in claim 14, wherein the plurality of stator cores include:
a plurality of support parts; and
a plurality of teeth parts extended from the plurality of support parts, respectively, and having the coil wound therearound.

16. The motor as set forth in claim 14, wherein the injection part is integrally formed on outer surfaces of end portions of the plurality of teeth parts by insert injection molding.

17. The motor as set forth in claim 15, wherein the teeth part includes:
a winding part extended from the support part and having the coil wound therearound; and
an extension part formed at an end portion of the winding part to prevent separation of the coil, and
the injection part is formed along an outer surface of the extension part.

18. The motor as set forth in claim 17, wherein the extension part is extended from the end portion of the winding part to both sides in a circumferential direction.

19. The motor as set forth in claim 14, wherein the stator further includes a plurality of stator blocks coupled between the plurality of stator cores.

20. The motor as set forth in claim 15, wherein the stator further includes a plurality of stator blocks coupled between the support parts of the plurality of stator cores and extended from the support parts in a circumferential direction.
